(19) United States
(12) Patent Application Publication
(10) Pub. No.: US 2007/0208581 A1
(43) Pub. Date: Sep. 6, 2007

(54) Query-able network address registry based on network address description and network presence level with a market for trading network presence level

(76) Inventor: Jody Le Ron Sharpe, Omaha, NE (US)

Correspondence Address: JODY SHARPE, 3121 N 100TH PLZ #3, OMAHA, NE, 68134, US

(21) Appl. No.: 11/358,528

(22) Filed: Feb. 21, 2006

(51) Int. Cl. G06Q 10/00; G06Q 30/00

(52) U.S. Cl. 705/1

(57) ABSTRACT

This invention provides a method for the exchange of Internet place utility on an open market similar to the stock market. This place utility comprises the products and services sold on the Internet such as job board postings, classified advertisements, search engine position, and etc. Internet place utility does not represent a physical entity such as an ounce of platinum, a bushel of wheat, or a barrel of crude oil. To this end, these portions of Internet place utility are a derivative of the traditional notion of Web Presence.

### CROSS-REFERENCE TO RELATED APPLICATIONS

### U.S. PATENT DOCUMENTS

| | | |
|---|---|---|
| 6990457 | Jan,, 2006 | Litman, et al. |
| 6983260 | January, 2006 | Hummelgren. |
| 6983259 | January, 2006 | Foray, et al. |
| 6983258 | January, 2006 | Tye, et al. |
| 6978253 | December, 2005 | Lin. |
| 6968318 | November, 2005 | Ferstenberg, et al. |
| 6950806 | September, 2005 | Dines. |
| 6912551 | June, 2005 | Albaugh, et al. |
| 6907402 | June, 2005 | Khaitan. |
| 6892186 | May., 2005 | Preist |
| 6876309 | April, 2005 | Lawrence. |
| 6691094 | February, 2004 | Herschkorn |
| 6594643 | July, 2003 | Freeny, Jr. |
| 6519574 | February, 2003 | Wilton, et al. |
| 6477647 | November, 2002 | Venkatraman, et al. |
| 6285989 | September, 2001 | Shoham |
| 6029146 | February, 2000 | Hawkins, et al. |
| 6014643 | January, 2000 | Minton. |
| 5918218 | January, 1999 | Harris, et al. |
| 5915209 | June, 1999 | Lawrence |
| 4674044 | June, 1987 | Kalmus, et al. |

### OTHER REFERENCES

Bakos, Y., “Reducing Buyer Search Cost: Implications for Electronic Marketplaces”, http://citeseer.ist.psu.edu/bakos97reducing.html, 1997.
Bakos, Y., “Bundling and Competition on the Internet”, http://citeseer.ist.psu.edu/bakos99bundling.html, 1999.
Bakos, Y., “The Emerging Landscape for Retail E-Commerce”, http://citeseer.ist.psu.edu/bakos01emerging.html, 2001.
Biswas, S., “Supplier Competition in Electronic Marketplaces”, http://citeseer.ist.psu.edu/529043.html. 2000.
Converse, P. Elements of Marketing. Sixth Edition. Prentice Hall, Englewood Cliffs, N.J. 1958, p 3-15.
Fink, E., “Exchange Market for Complex Goods: Theory and Experiment”, http://citeseer.ist.psu.edu/646211.html. 2002.
Rust, J., “Middle Men versus Market Makers: A Theory of Competitive Exchange”, http://citeseer.ist.psu.edu/rust01middle.html. 2001.
Smith, M., “Understanding Digital Markets: Review and Assessment”, http://citeseer.ist.psu.edu/smith99understanding.html. 1999.

### STATEMENT REGARDING FEDERALLY SPONSORED RESEARCH OR DEVELOPMENT

This is a substitute specification for application No. 60/658,213. It contains no new matter.

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The use of the Internet exploded in the late nineteen nineties. Its growth has slowed over the past few years. However, it remains a viable and growing market place. Currently, most of the business to consumer and business to business products and services sold on the Internet are sold for the consumption of consumers and businesses. Little opportunity exists for consumers and businesses to purchase new consumer and business products and services by bidding for them at wholesale prices. And, rarely do the consumers or businesses have an opportunity to offer any unused portion of that purchased product or service for resale at a profit. Some Internet services offer the opportunity to exchange products based on bidding, but these exchanges are usually for very small quantities of items, many of the items are second hand, rarely do the items represent services such as search engine position, classified ad postings, or other forms of Internet place utility. A need exists for an Internet service that provides an open marketplace for the exchange of these types of Internet products, called Web Presence. This open market for the exchange of Web Presence reduces the possibility of price-fixing monopolies or oligarchies developing on the Internet.

### BRIEF SUMMARY OF THE INVENTION

To achieve this goal, the current invention has been envisioned and reduced to practice. The current invention provides a generic interface and mechanism that will allow any Internet business to consumer or business to business, product or service provider to allow his product or service to be purchased or sold in the Web Presence open market. This generic mechanism provides means for a trader of Web Presence to communicate their desires to purchase or sell units of Web Presence: Internet place utility such as search engine position, classified ads, etc. In the case of the place utility created by search engine position, a trader can purchase or sell search engine place utility associated with the network address that he registered with the search engine. This place utility is proportional to the level of network presence. In the case of a classified ad service, the network address associated with each ad represents a level of network presence, Internet place utility. Traders of this form of Web Presence can buy and sell units of this utility. The average number of page impressions that the classified ad can receive will influence the value of this utility. Any software system that provides a service or product whose value derives from Internet place utility can represent a component system that interacts with the trading system represented in the current invention. This generic mechanism also provides a means for keeping an account of trader's transactions, Web Presence portfolios, and account balances. Plus, this generic mechanism provides a means for maintaining a list of Web Presence trader membership. This generic mechanism provides its services to other Internet service providers through a set of common interface services.

### BRIEF DESCRIPTION OF THE SEVERAL VIEWS OF THE DRAWING

FIG. 1 is a depiction of the current invention using the Unified Modeling Language.

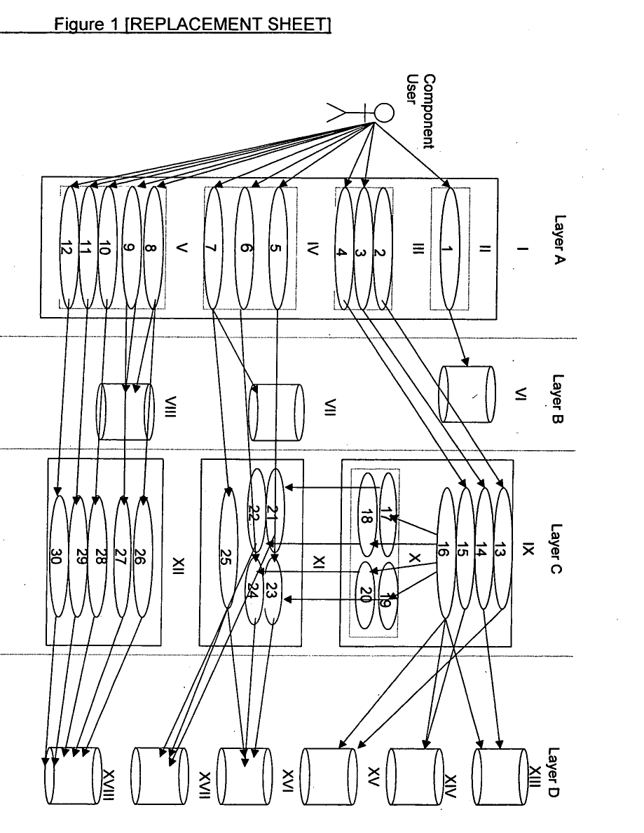

FIG. 2 is a key for the System Uses in FIG. 1.

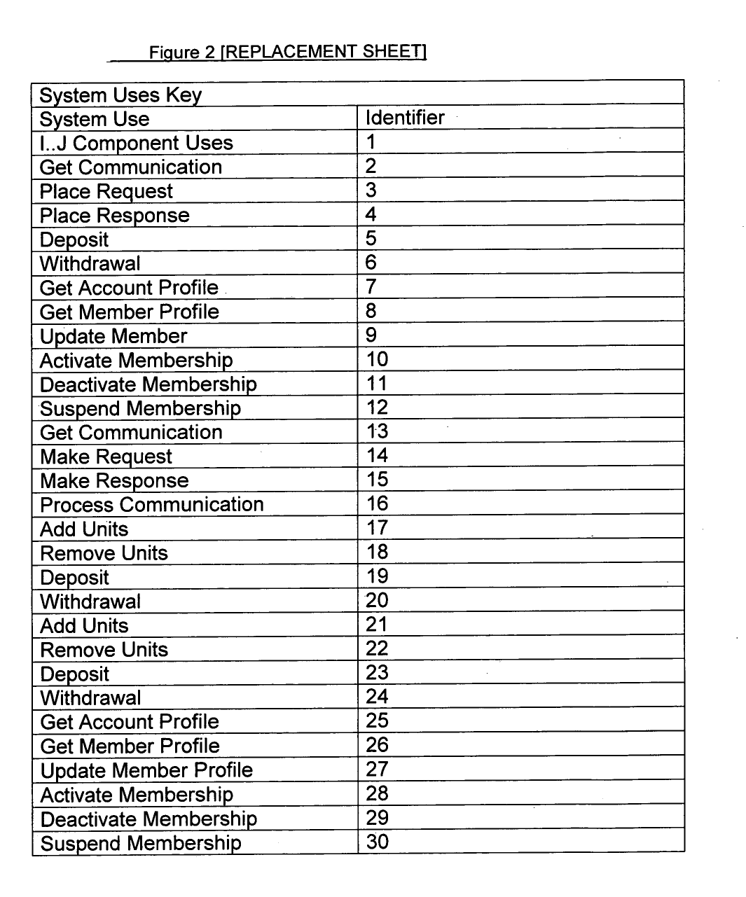

FIG. 3 is a key for the Systems and Subsystems in FIG. 1.

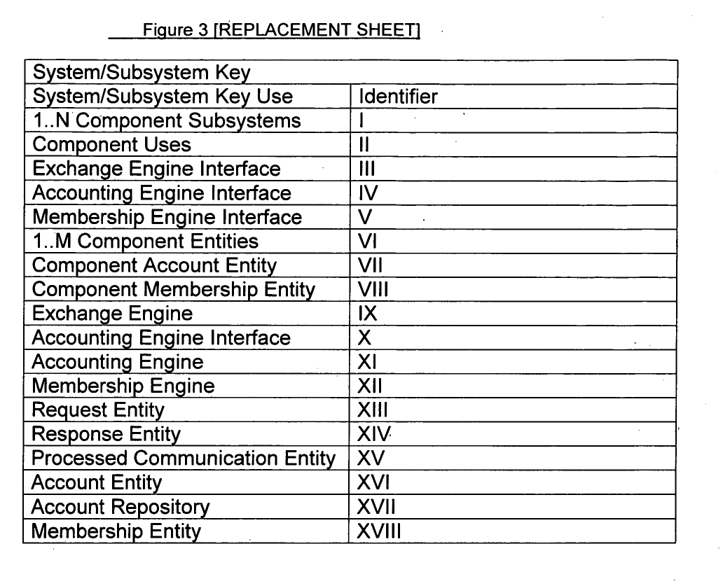

### DETAILED DESCRIPTION OF THE INVENTION

The following describes the present invention in detail.

As described by the diagram, the software system has four layers: A, B, C, and D. The following four sections describe each layer of the software system and the software components that comprise each layer.

Layer A. This layer represents the highest layer of the system. This layer consists of one or more component systems with unique components uses. In other words, each one of these component systems provides a different set of services to the respective component user. These unique services are represented by the 1..j component uses in each component system. Also, each of the component systems has the same interface to the lower layers: B, C, and D, of the software system. The 1..n component systems and their interface to the lower layers are described below.

Layer A. 1..N Component Systems Consist of:

1..J Component Uses. Provides the unique services of each component to the component user. These services use the 1..m component entities in layer B to store and retrieve component-specific data as needed.

Exchange Engine Interface. Provides three basic services as an interface to the lower layers of the software system: place request, place response, and get communication. These services communicate with the make request, make response, get communication services of the Exchange Engine in layer C, respectively.

Accounting Engine Interface. Provides three basic services as an interface to the lower layers of the software system: deposit, withdrawal, and get account profile. These services communicate with the deposit, withdrawal, and get account profile services of the Accounting Engine in layer C, respectively. The get account profile service uses the component accounting entity in layer B to store and retrieve component-specific data as needed.

Membership Engine Interface. Provides five basic services as an interface to the lower layers of the software system: get member profile, update member profile, activate membership, deactivate membership, and suspend membership. These services communicate with the get member profile, update member profile, activate membership, deactivate membership, and suspend membership services of the Membership Engine in layer C, respectively. The get member profile and update member profile use the component membership entity in layer B to store and retrieve component-specific data as needed.

Layer B. Component Layer Entity Classes Consists of:

1..M Component Entities. Store data for the 1..J component uses provided by each component system in layer A that is unique to each component system.

Component Accounting Entity. Stores data for the component accounting engine interface provided by each system in layer A that is unique to each component system.

Component Membership Entity. Stores data for the component membership engine interface provided by each system in layer A that is unique to each component system.

Layer C. System Engine Layer Consists of:

Exchange Engine. Facilitates communication among component users who exchange units of component services for units of currency. Provides three basic services as an interface to the higher layers of the software system: make request, make response, and get communication. These services communicate with the place request, place response, and get communication services of the 1..n component services in layer A, respectively. These three services also communicate with the lowest layer of the system: layer D. Make request and make response use the request entity and response entity, respectively, to store and retrieve data for the exchange engine. Get communication retrieves processed communication from the processed communication entity in layer D. The exchange engine contains one utility service, process communication. This utility service communicates with the lowest layer of the software system, layer D. Process communication retrieves pending request and responses from the request entity and the response entity, processes them and stores the result of the communication in the processed communication entity. The processing engine also updates the appropriate accounting information in order to fulfill the communication request and response via the add units, remove units, deposit, and withdrawal services of the accounting engine interface of the exchange engine in layer C.

Accounting Engine Interface. The exchange engine also contains an interface to the accounting engine. This interface provides four services: add units, remove units, deposit, and withdrawal. Theses services communicate with the add units, remove units, deposit, and withdrawal services of the accounting engine that is also in layer C.

Accounting Engine. The accounting engine provides five services: add units, remove units, deposit, withdrawal, and get account profile. The add units and remove units services communicate with the add units and remove units services in the accounting engine interface of the exchange engine in layer C. They also store and retrieve data as necessary from the account repository. The deposit and withdrawal services communicate with the deposit and withdrawal services in the accounting engine interface in the exchange engine in layer C and the deposit and withdrawal services in the accounting engine interface of the 1..n component uses in layer A. They also store and retrieve data as necessary from the account entity in layer D. Finally, the get account profile service communicates with the get account profile service in the accounting engine interface of the 1..n component systems in layer A, plus stores and retrieves data as needed from the account entity in layer D.

Membership Engine. The membership engine provides five services: get member profile, update member profile, activate membership, deactivate membership, and suspend membership. These services communicate with the get member profile, update member profile, activate membership, deactivate membership, and suspend membership services in the membership engine interface of the 1..N component systems in layer A. They also store and retrieve data as needed from the membership entity.

Layer D. Engine Layer Entity Classes Consists of:

Request Entity. Stores all of the data associated with 1..n component service exchange requests that have been made by component users via the exchange engine.

Response Entity. Stores all of the data associated with 1..n component service exchange responses that have been made by component users via the exchange engine.

Processed Communication Entity. Stores all the data associated with completed communication between component users who make exchange request and component users who make exchange responses.

Account Entity. Stores all the non component-specific accounting information for a component user.

Account Repository Entity. Stores all the accounting information for a component user relating to the component user's portfolio of 1..n component services available for exchange.

Membership Entity. Stores all of the non component-specific membership information for a component user.

Standard Usage. The component user will only interact with the layer A services provided by each of 1..n component systems. The following describes the sequence of events that occur when a component user interacts with each service.

Component Uses. The component user interacts with one or more of the 1..j component uses of a single component system. Some of these services are cost-free and others have a fee. Each of these services store and retrieve data from each of the 1..m component entities associated with this particular component system as needed.

Exchange Engine. The component user can place a request to sell or purchase one or more units of a fee-based component service. This fee-based component service is one of the 1..j component uses that is fee-based. Each on the 1..n component systems may have one or more fee based component services. When this request to buy or sell is made it is propagated to the exchange engine and stored in the request entity as a pending request.

The component user can place a response to a request to sell or purchase one or more units of a fee-based component service. This fee-based component service is one of the 1..j component uses that is fee-based. Each on the 1..n component systems may have one or more fee based component services. When this response to a request to buy or sell is made it is propagated to the exchange engine and stored in the response entity as a pending response.

The process communication utility service of the exchange engine matches request with responses and communicates the updates to component users accounting data stored in the account entity and account repository entity in layer D through the accounting engine via the account engine interface. The accounting engine interface achieves this communication processing by adding units of fee-based component services, removing units of fee-based component services, depositing funds in a component users account, or removing funds from a component user's account as necessary. This utility service also applies usage fees placed on the buyer and seller to their account, notifies them, and stores a list of completed transaction in the processed communication entity.

The component user can get a record of all of the processed communication transactions that he was a part of through the get communication service of the individual component system that he is using. This service will communicate with the get communication service of the exchange engine in layer C that will retrieve the information from the processed communication entity in layer D and return it to layer A.

Account Engine. The component user can deposit funds to and withdraw funds from his account using the deposit and withdrawal services of the accounting engine interface in each component system of the 1..n component systems. These services in layer A communicate with the deposit and withdrawal services in the accounting engine of layer C, respectively. In turn, the services in layer C store and retrieve data as needed from the account entity class in Layer D in order to update balance information.

The component user can retrieve account profile information using the get account profile service of the accounting engine interface in layer A. This service retrieves any needed data from the component-specific component accounting entity in layer B and retrieves any non-component specific accounting information from the account entity in layer D via the get account profile service of the accounting engine in layer C.

Membership Engine. The component user can retrieve or update any component-specific membership information in the component membership entity in layer B with the get member profile and update member profile services in the membership engine interface of layer A. The component user can activate, deactivate, or suspend his membership by using the activate membership, deactivate membership, and suspend membership services in the membership engine interface in layer A. These service update non component-specific membership information in the membership entity of layer D via the activate membership, deactivate membership, and suspend membership services of the membership engine in layer C.

1. A place utility service and place utility product exchange system comprising:
An exchange communication means for potential buyers and sellers of units of a place utility service or place utility products who wish to communicate their desire to exchange units of currency for units of place utility services and place utility products.
An exchange accounting means for accounting for the exchange of units of a place utility product or a place utility service for units of currency.
A membership recording means for recording membership in the group of potential buyers and sellers of the units of place utility services or place utility products that limit access to the exchange communication means based on membership.

1. A place utility service and place utility product exchange system comprising an exchange communication means for potential buyers and sellers of units of a place utility service or place utility products who wish to communicate their desire to exchange units of currency for units of Place utility services and place utility products.

2. A Place utility service and place utility product exchange system comprising an exchange accounting means for accounting for the exchange of units of a place utility product or a place utility service for units of currency.

3. A place utility service and place utility product exchange system comprising a membership recording means for recording membership in the group of potential buyers and sellers of the units of place utility services or place utility products that limit access to the exchange communication means based on membership.

2. A place utility service and place utility product exchange system of claim 1 comprising:
An exchange communication means fee means for determining the fee to be placed on the buyers and sellers exchanging units of a place utility service or a place utility product.
A fee placement notification sending means for sending fee placement notices to the buyers and sellers exchanging units of a place utility service or a place utility product.

4. A place utility service and place utility product exchange system of claim 1 comprising an exchange communication means fee means for determining the fee to be placed on the buyers and sellers exchanging units of a place utility service or a place utility product.

5. A place utility service and place utility product exchange system of claim 1 comprising a fee placement notification sending means for sending fee placement notices to the buyers and sellers exchanging units of a place utility service or a place utility product.

3. A place utility service and place utility product exchange system of claim 1 comprising:
A database for storing pending exchange communication between buyers and sellers of units of a place utility service or a place utility product.
A database for storing a history of completed exchange communication between buyers and sellers of units of a place utility service or a place utility product.

6. A Place utility service and place utility product exchange system of claim 1 comprising a database for storing pending exchange communication between buyers and sellers of units of a place utility service or a place utility product.

7. A place utility service and place utility product exchange system of claim 1 comprising a database for storing a history of completed exchange communication between buyers and sellers of units of a place utility service or a place utility product.

4. A place utility service and place utility product exchange system of claim 1 comprising:
A database for storing exchange accounting information.

8. A place utility service and place utility product exchange system of claim 1 comprising a database for storing exchange accounting information.

5. A place utility service and place utility product exchange system of claim 1 comprising:
A database for storing a membership record for each buyer and seller of units of a place utility service or a place utility product that have access to the exchange communication means.

9. A place utility service and place utility product exchange system of claim 1 comprising a database for storing a membership record for each buyer and seller of units of a place utility service or a place utility product that have access to the exchange communication means.

6. A computer-implemented place utility service and place utility product exchange system comprising:
Communicating exchange request between buyers and sellers of units of a place utility service or a place utility product who wish to exchange units of a place utility service or a place utility product for units of currency.
Accounting for exchanges of units of a place utility service or a place utility product for units of currency.
Recording membership of buyers and sellers of units of a place utility service or a place utility product who have access to the exchange communication means.

10. A computer-implemented place utility service and place utility product exchange system comprising communicating exchange request between buyers and sellers of units of a place utility service or a place utility product who wish to exchange units of a place utility service or a place utility product for units of currency.

11. A computer-implemented place utility service and place utility product exchange system comprising accounting for exchanges of units of a Place utility service or a place utility Product for units of currency.

12. A computer-implemented place utility service and place utility Product exchange system comprising recording membership of buyers and sellers of units of a place utility service or a place utility product who have access to the exchange communication means.
